(19) United States
(12) Patent Application Publication
(10) Pub. No.: US 2008/0113289 A1
(43) Pub. Date: May 15, 2008

(54) Polyester Resin and Toner Including the Same

(76) Inventors: Jae-Kyoung Roh, Kyonggi-Do (KR); Young-Man Yoo, Kyonggi-Do (KR); Kyoung-Ha Lee, Kyonggi-Do (KR); Kye-Yune Lee, Kyonggi-Do (KR); Tae-Woong Lee, Kyonggi-Do (KR)

Correspondence Address: BIRCH STEWART KOLASCH & BIRCH, PO BOX 747, FALLS CHURCH, VA, 22040-0747, US

(21) Appl. No.: 11/793,761

(22) PCT Filed: Dec. 21, 2005
(86) PCT No.: PCT/KR05/04431

§ 371 Date: Jun. 21, 2007

(30) Foreign Application Priority Data
Dec. 23, 2004 (KR) 10-2004-011140

(51) Int. Cl. G03G 9/087

(52) U.S. Cl. 430/109.4

(57) ABSTRACT

A polyester resin for toner, which has superior fixing property, storage stability, and image density in an electrophotographic image forming process or an electrostatic printing process, and a toner including the same are disclosed. The polyester resin for toner is produced by carrying out esterification reaction and polycondensation reaction of reactant comprising aromatic dibasic acid of 80 to 100 mol % with respect to the total dibasic acid, trivalent or higher acid of 0.5 to 30 mol % with respect to the total dibasic acid, aromatic diol of equal to or less than 90 mol % with respect to the total dibasic acid, and aliphatic diol of 10 to 80 mol % with respect to the total dibasic acid, in the presence of a polycondensation catalyst selected from the group consisting of TiO₂/SiO₂ coprecipitates, TiO₂/ZrO₂ coprecipitates and the mixture thereof.

### TECHNICAL FIELD

This invention relates to a polyester resin and a toner including the same, and more specifically to a polyester resin for toner, which has superior fixing property, storage stability, and image density in an electrophotographic image forming process or an electrostatic printing process, and a toner including the same.

### BACKGROUND ART

In general, an electrophotographic image forming process or an electrostatic printing process includes the steps of (a) forming an electro-conductive image, or a statically charged image (hereinafter latent image ), which corresponds to a recording image, on a surface of an electrostatic recording medium, (b) developing the latent image with charged toner, (c) transferring the toner image to a recording material such as a paper or a recording film, and finally (d) fixing the transferred image. The image-forming process has advantages in that the copied or the printed material can be obtained with a high speed, the image formed on the electrostatic recording medium is stable, and an image-forming device is easy to manipulate. Therefore, the image-forming process is widely used in the field of copiers and printers. In more detail, the image-forming process comprises the steps of (1) charging process for electrically charging a drum (for example, organic photoconductor drum: OPC) coated with a photoconductive or a photosensitive material, (2) exposing process for forming an electrostatic latent image on the drum with the light reflected from the original image being copied, (3) developing process for statically adhering a charged toner onto the latent image, (4) transferring process for sticking a charged paper to the drum, and transferring the toner image on the drum to the charged paper, (5) fixing process for fixing the transferred toner on the paper by heating and compressing with a thermopressing roller, (6) cleaning process for removing the residual toner on the drum, and (7) charge removing process for removing the residual charge on the drum.

The toner useful in a dry developing process can be classified into one-component toner, two-component toner, etc. The two-component toner may include a binder resin, a coloring agent, an electrification control agent, and other additives. If a magnetic drum is used, the toner further includes a magnetic material for developing the magnetic latent image formed on the drum. The toner is produced by melting, kneading and dispersing the components, and the toner of particle shape is produced by pulverizing and classifying the kneaded components. The physical properties of the toner mainly depend on the binder resin, which is a main component of the toner. Accordingly, the binder resin is desirable to have good characteristics in dispersibility of the coloring agent during melting and kneading process, fixing property, offset preventing property, storage stability, other electronic property, and transparency. In addition, the binder resin should be colorless to produce a clear image, to produce a wide range of color image, and to provide superior image density on the copied material. The binder resin also should be environmentally favorable.

As the binder resin, a polyester resin is widely used due to its superior fixing property, transparency, and so on, in place of conventional resins such as polystylene resin, stylene acrylic resin, epoxy resin, polyamide resin, and so on. As a catalyst for preparing the polyester resin, germanium catalyst, antimony catalyst, tin catalyst, etc., have been used. However, the conventional catalysts have a low activity and should be used in large amount, and thereby are not favorable in the environmental aspect. In addition, the conventional catalysts have their characteristic colors in the produced polyester (for example, antimony catalyst produces gray color in the produced polyester), which deteriorates the transparency of the produced polyester resin. Therefore, it is tried to partially or fully replace the conventional catalysts with titanium catalysts such as tetraethyl titanate, acetyltripropyl titanate, tetrapropyl titanate, tetrabutyl titanate, polybutyl titanate, ethylacetoacetic ester titanate, isostearyl titanate, or titanium dioxide to improve the catalytic activity and the transparency of the polyester resin. The titanium catalyst is used in small amount when compared with the antimony catalyst, and the catalytic activity is relatively superior. However, the titanium catalyst has problems in that the activity is lowered when the catalyst reacts with water, and large amount of the catalyst should be used in water-containing reaction condition. Also, the titanium catalyst is liable to be precipitated which makes it difficult to handle and store the catalyst. In addition, the color and transparency of the polyester produced with the titanium catalyst are not fully satisfactory.

### DISCLOSURE OF INVENTION

### Technical Problem

The inventors of the present invention have discovered that a polyester resin produced in the presence of the polycondensation catalyst including TiO₂/SiO₂ coprecipitates and/or TiO₂/ZrO₂ coprecipitates disclosed in U.S. Pat. Nos. 5,684,116, and 5,789,528, has good physical properties as the binder resin for toner.

Therefore, it is an object of the present invention to provide a toner having superior storage stability and fixing property, and a polyester resin for producing the toner.

It is other object of the present invention to provide a toner having superior transparency, clear coloring property, and image density, and being capable of displaying various colors, and a polyester resin for producing the toner.

It is another object of the present invention to provide a toner which is environmentally favorable.

### Technical Solution

To accomplish these objects, the present invention provides a polyester resin for toner produced by carrying out esterification reaction and polycondensation reaction of reactant comprising aromatic dibasic acid, trivalent or higher acid, aromatic diol and aliphatic diol, in the presence of a polycondensation catalyst selected from the group consisting of TiO₂/SiO₂ coprecipitates, TiO₂/ZrO₂ coprecipitates and the mixture thereof. The present invention also provides a toner produced including the polyester resin. With respect to the total dibasic acid, the amount of the aromatic dibasic acid is 80 to 100 mol %, the amount of the trivalent or higher acid is 0.5 to 30 mol %, the amount of the aromatic diol is equal to or less than 90 mol %, and the amount of the aliphatic diol is 10 to 80 mol %. Also, the amount of the polycondensation catalysts is preferably 4 to 400 ppm with respect to the total acid components. If necessary, the reactant further includes aliphatic dibasic acid, trihydric or higher alcohol or stabilizer. With respect to the total dibasic acid, the preferable amount of the aliphatic dibasic acid is equal to or less than 20 mol %, and the preferable amount of the trihydric or higher alcohol is 0.5 to 50 mol %. The preferable amount of the stabilizer is equal to or less than 300 ppm with respect to the total acid components.

### MODE FOR THE INVENTION

A more complete appreciation of the invention, and many of the attendant advantages thereof, will be better appreciated by reference to the following detailed description.

The reactant for preparation of a polyester resin for toner according to the present invention includes aromatic dibasic acid, alkyl ester thereof and/or anhydride thereof as the main component, which is conventionally used in the preparation of a polyester resin. The representative examples of the aromatic dibasic acid include terephthalic acid and isophthalic acid, and examples of the alkyl ester thereof includes dimethyl terephthalate, dimethyl isophthalate, diethyl terephthalate, diethyl isophthalate, dibutyl terephthalate, and dibutyl isophthalate. The aromatic dibasic acid, alkyl ester thereof and anhydride thereof (hereinafter, collectively “aromatic dibasic acid” can be used independently or in combination. The aromatic dibasic acid has a benzene ring of a high hydrophobic property, and thereby can improve the moisture-proof property of a toner and increase the glass transition temperature (Tg) of the produced resin, which results in the improved storage stability of the toner. The amount of the aromatic dibasic acid is preferably 80 to 100 mol % to the total dibasic acid (i.e., the amount of the aromatic dibasic acid is 80 to 100 mol in the 100 mole of the total dibasic acid), and more preferably 90 to 100 mol %. The terephthalic acid increases toughness and glass transition temperature (Tg) of the produced resin, and the isophthalic acid increases reactivity. Therefore, the ratio of terephthalic acid and isophthalic acid can be varied according to the desired property of the produced polyester resin.

The reactant for preparation of a polyester resin for a toner according to the present invention includes trivalent or higher acid. Non-limiting examples of the trivalent or higher acid include trimellitic acid, pyromellitic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,2,7,8-octanetetracarboxylic acid, alkyl ester thereof, and acid anhydrides thereof (hereinafter, collectively “trivalent or higher acid”. The trivalent or higher acid can be used independently or in combination. The trivalent or higher acid increases Tg and cohesive property of the produced resin, which results in the improvement of the offset preventing property of the toner. The amount of the trivalent or higher acid is 0.5 to 30 mol %, and preferably 1 to 25 mol % with respect to the total dibasic acid. If the amount of the trivalent or higher acid is more than 30 mol %, it is difficult to obtain the desired polyester resin because it is difficult to control the gelation of the resin during the resin production process.

The reactant for preparation of a polyester resin for a toner according to the present invention includes aromatic diol. The aromatic diol increases Tg of the resin and improves the storage stability of the toner. The aromatic diol can be properly used as the alcohol component of a polyester resin for a toner. The aromatic diol includes bisphenol A derivative, and examples of bisphenol A derivative include polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0)-2,2-bis(4-hydroxyphenyl)propane, polyoxyethylene-(2.3)-2,2-bis(4-hydroxyphenyl)propane, polyoxypropylene-(6)-2,2-bis(4-hydroxyphenyl) propane, polyoxypropylene-(2.3)-2,2-bis(4-hydroxyphenyl)propane, polyoxypropylene-(2.4)-2,2-bis(4-hydroxyphenyl)propane, polyoxypropylene-(3.3)-2,2-bis(4-hydroxyphenyl)propane, polyoxyethylene-(3.0)-2,2-bis(4-hydroxyphenyl) propane, polyoxyethylene-(6)-2,2-bis(4-hydroxyphenyl)propane, and so on. The aromatic diols can be used independently or in combination. The amount of the aromatic diol is preferably equal to or less than 90 mol % with respect to the total dibasic acid (i.e., the amount of aromatic diol is equal to or less than 90 mol with respect to 100 mole of the total dibasic acid), and more preferably, equal to or less than 85 mol %. Also, the amount of the aromatic diol having 2 moles of ethylene oxide and/or propylene oxide is equal to or more than 85 weight % of the total aromatic diol, and the amount of the aromatic diol having 1 mole of ethylene oxide and/or propylene oxide is less than 0.2 weight % to the total aromatic diol. The aromatic diol increases Tg of the resin and the storage stability of the toner, but if the amount of the aromatic diol is more than 90 mol %, the polymerization reaction rate considerably decreases. Accordingly, the aromatic diol should be properly used with considering the properties and the reactivity.

The reactant for preparation of a polyester resin for a toner according to the present invention includes aliphatic diol. Examples of the useful aliphatic diol include ethylene glycol, diethylene glycol, neopentyl glycol, propylene glycol, butane diol, and so on. Among the aliphatic diols, ethylene glycol, neopentyl glycol, and butane diol are preferred when considering the fixing property of a toner. The aliphatic diols are used independently or in combination. The aliphatic diol improves the polycondensation reaction rate, makes the resin to have the plasticity, and improves the fixing property, but decreases Tg, and deteriorates the storage stability of a toner. Therefore, it is preferable to use the proper amount of the aliphatic diol according to kinds of machines where the toner is used. The amount of the aliphatic diol is preferably 10 to 80 mol % with respect to the total dibasic acid, and more preferably 15 to 75 mol %.

The reactant for preparation of a polyester resin for a toner according to the present invention, if necessary, includes aliphatic dibasic acid, alkyl ester thereof and/or acid anhydride thereof. Non-limiting examples of the compounds include aliphatic dibasic acid such as sebacic acid, isodecyl succinic acid, maleic acid, fumaric acid, adipic acid, and so on, and their monomethyl, monoethyl, dimethyl and diethyl ester, and their acid anhydrides (hereinafter, collectively “aliphatic dibasic acid”. The aliphatic dibasic acid influences considerably on the fixing property and the storage stability of a toner. Therefore, the aliphatic dibasic acid should be properly used according to the demanded property of a resin, and the preferable amount of the aliphatic dibasic acid is equal to or less than 20 mol %, and preferably 0.1 to 20 mol % with respect to the total dibasic acid.

The reactant for preparation of a polyester resin for a toner according to the present invention, if necessary, includes trihydric or higher alcohol. Non-limiting examples of the trihydric or higher alcohol include sorbitol, 1,2,3,6-hexanetetrol, 1,4-sorbitane, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. The trihydric or higher alcohol can be used independently or in combination. The trihydric or higher alcohol increases the Tg of a produced resin, makes resin to have a cohesive property, and improves the storage stability of a toner. The amount of the trihydric or higher alcohol is equal to or less than 50 mol %, preferably 0.5 to 50 mol % and more preferably 1 to 25 mol % with respect to the total dibasic acid. If the amount of the trihydric or higher alcohol is more than 50 mol %, it is difficult to obtain a desirable resin because it is difficult to control the gelation of a polyester resin during preparation of a polyester resin. In case of using two or more of the trihydric or higher alcohols, the total amount of the trihydric or higher alcohols is equal to or less than 50 mol % to the total dibasic acid.

As the polycondensation catalysts for producing a polyester resin for a toner according to the present invention, TiO₂/SiO₂ coprecipitates, TiO₂/ZrO₂ coprecipitates, or the mixture thereof can be used. Among them, TiO₂/SiO₂ coprecipitates is preferred when considering the sensitivity to water, the storage stability, the easy handling, and color and transparency of a produced polyester resin. The TiO₂/SiO₂ coprecipitates and TiO₂/ZrO₂ coprecipitates are an oxide co-polymer having alternating “—Ti—O—” and “—Si—O—” or “—Zr—O—” bonds. For example, as shown in Reaction 1 and Reaction 2, wherein R is alkyl group, the coprecipitates can be produced by preparing a silanol by hydrolyzing tetraalkoxysilane, and by carrying out a condensation reaction of the silanol and titanium(IV) or zirconium(IV) tetraalcoholate. The TiO₂/SiO₂ coprecipitates and TiO₂/ZrO₂ coprecipitates can be prepared by various methods. For example, as disclosed in U.S. Pat. No. 5,684,116, the coprecipitates can be prepared by dissolving titanium(IV) tetraisopropylate and tetraetoxysilane with absolute ethanol, adding water/ethanol mixture into the solution, carrying out reaction preferably at room temperature to obtain white precipitates, and separating centrifugally, cleaning, and drying the obtained precipitates. The mole ratio of TiO₂: SiO₂ is preferably 90:10 to 20:80, and the mole ratio of TiO₂: ZrO₂ is preferably 95:5 to 70:30.

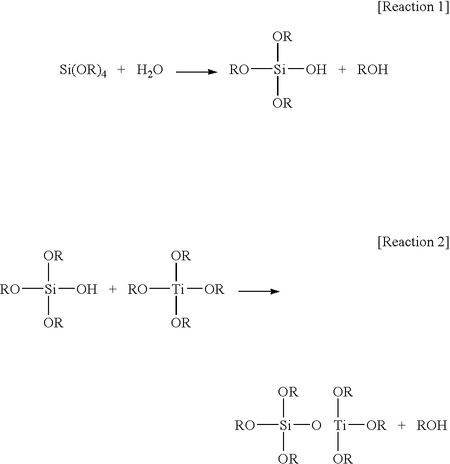

The amount of the polycondensation catalyst is preferably 4 to 400 ppm with respect to the total acid components. If the amount of the catalyst is less than 4 ppm, the polymerization degree of a polyester resin is not satisfactory, and if the amount of the catalyst is more than 400 ppm, the coprecipitates catalyst may not be completely dissolved, which decreases the polymerization reaction rate and deteriorates the transparency a polyester resin.

The reactant for preparation of a polyester resin for a toner according to the present invention, if necessary, further includes additives such as a stabilizer. For example, the stabilizer controls the activity of the coprecipitates catalyst, and various conventional stabilizers can be used in the present invention. Non-limiting examples of the stabilizer include phosphoric acid, trimethyl phosphate, triethyl phosphate, and so on. The concentration of the stabilizer is preferably equal to or less than 300 ppm, and preferably 10 to 300 ppm with respect to the total acid components. Preferably, the amount of phosphorus (P) of the stabilizer is equal to or less than 100 ppm with respect to the final produced polyester. If the amount of the stabilizer is too small, the reaction rate decreases, and if the amount of the stabilizer is more than the above range, the polymerization degree of a polyester resin decreases.

The polyester resin according to the present invention can be prepared by conventional two steps of an esterification reaction or ester exchange reaction and a polycondensation reaction. To prepare a polyester resin according to the present invention, the acid components and the alcohol components are charged into a reactor and heated to carry out the esterification or ester exchange reaction. Then, if necessary, well known and generally used catalyst for the esterification or ester exchange reaction, such as titanium butoxide, dibutyl tin oxide, magnesium acetate, manganese acetate, and so on can be used. The esterification or ester exchange reaction is, for example, carried out under nitrogen flow at 230 to 260° C., while removing the water or alcohol produced from the reaction in conventional way. After completion of the reaction, the polycondensation reaction is carried out. The polycondensation reaction can also be carried out under the conventional conditions, for example, at temperature of 240 to 260° C. or preferably at temperature of less than 250° C. The polycondensation reaction can includes the steps of (a) reacting the reactant under high-vacuum and high speed stirring, as the first step, (b) then changing the high-vacuum to an atmospheric pressure by injecting nitrogen gas in the reactor and reacting the reactant under the high speed stirring, and (c) reacting the reactant under an atmospheric pressure and low speed stirring. During the polycondensation reaction, the byproduct such as glycol can be removed by distillation. In the first step of the polycondensation reaction, the high vacuum is a pressure of equal to or less than 100 mmHg, and preferably equal to or less than 30 mmHg. By maintaining the high vacuum, the low boiling point byproduct can be removed from the reaction products.

The acid value of the polyester resin according to the present invention is preferably 1 to 25 KOHmg/g, and more preferably 5 to 20 KOHmg/g. If the acid value is less than 1 KOHmg/g, developing of a latent image with toner and transferring of the developed toner are not satisfactorily performed, and the image can be deteriorated. If the acid value is more than 25 KOHmg/g, the storage stability of a polyester resin during storage or in a developing machine can be deteriorated. The softening temperature of the polyester resin is preferably 130 to 190° C., and more preferably 140 to 180° C. If the softening temperature is less than 130° C., Tg can be lowered, and the storage stability can be deteriorated, and thereby the toner particles can be aggregated during storage. If the softening temperature is more than 190° C., the low-temperature fixing property is deteriorated, and the offset may cause. The Tg of the polyester resin is preferably 50 to 70° C. If the Tg is less than 50° C., the storage stability of the toner can be deteriorated, and if the Tg is more than 70° C., the low-temperature fixing property of the toner can be deteriorated, especially when the large size polyester particles are used as the binder, and superior image can not be obtained.

The polyester resin according to the present invention is used as the main component of a binder resin for the preparation of toner, and if necessary, other resin such as styrene resin or styrene-acryl resin can be used in combination with the polyester resin. The amount of the binder resin in a toner is preferably 30 to 95 weight %, and more preferably 35 to 90 weight %. If the amount of the binder resin is less than 30 weight %, the offset preventing property of a toner tends to be deteriorated, and if the amount of the binder resin is more than 95 weight %, the charging stability of a toner tends to be deteriorated.

The polyester resin according to the present invention can be used with a coloring agent of a toner. Examples of the coloring agent include carbon black, nigrosine dyes, lamp black, sudan black SM, naval yellow, mineral fast yellow, litol red, permanent orange 4R, and so on. Also, the polyester resin according to the present invention can be used with various additives, which are components of a toner, such as wax, electrification control agent, offset preventing agent, magnetic material, and so on. Such additives are conventionally used for producing the toner. Examples of wax include polypropylene wax, and examples of the electrification control agent include nigrosine, azine-based dye containing alkyl group, basic dye, monoazo dye and their metal complex, salicylic acid and its metal complex, alkyl salicylic acid and its metal complex, naphthoic acid and its metal complex, etc. Examples of the offset preventing agent include polyethylene, polypropylene, ethylene-polypropylene copolymer, etc., and examples of the magnetic material(powder) include ferrite, magnetite, etc. The toner, which includes a polyester resin according to the present invention as the binder resin, can be prepared in conventional methods. For example, the toner can be prepared by kneading polyester resin as binder resin, coloring agent, and additives with a uniaxial or biaxial extruder or mixer at a temperature of 15 to 30° C. higher than the softening temperature of the binder, and pulverizing the kneaded product to particles. The average size of the prepared toner particles is preferably 5 to 10 micrometer and more preferably 7 to 9 micrometer. It is preferable that the amount of the minute particles having the particle size of less than 5 micrometer is less than 3 weight % with respect to the total toner.

The following examples and comparative examples are provided to illustrate the present invention in more detail, but the present invention is not limited by the following examples. The test methods used in the examples are as follows:

(1) Glass Transition Temperature (Tg, ° C.)

The glass transition temperature was measured with a differential scanning calorimeter (manufactured by TA Instruments) while increasing a sample temperature by 10° C./minute after hank you for your letters of Sep. 20 and 22, 2005 melting and quenching the sample. The Tg was determined from the mid value of tangent lines of the base lines of an endothermic curve.

(2) Softening Temperature (° C.)

The softening temperature was determined with a flow tester(CFT-500D, manufactured by Shimadzu Laboratories), and is a temperature at the moment that the half of 1.5 g sample flows out from a 1.0Φ×10 mm(height) nozzle under the conditions of 10 kgf of load, and temperature increase rate of 6° C./minute.

(3) Acid Value (KOHmg/g): Resin was dissolved with dichloromethane, cooled, and titrated with 0.1N KOH-methanol solution.

(4) Gelation and Non-reaction of polymerization product

In the polycondensation reaction, the case that the product cannot be obtained from the reactor because of the increase of viscosity was defined as “gelation”, and the case that the polymerization time is more than 500 minutes due to the slow reaction rate was defined as “non-reaction”, and other normal reaction was defined as normal .

(5) Color: The color was measured with a colorgard system manufactured by Pacific Scientific Company.

(6) Minimum Fixing Temperature and Offset Temperature: After coating a white paper with the produced toner, the paper was passed through a heat roller coated with silicon oil with a speed of 200 mm/second. The lowest temperature at which more than 90% of toner was fixed was defined as the minimum fixing temperature. The highest temperature at which more than 90% of toner was fixed was defined as the offset temperature. The minimum fixing temperature and the offset temperature were measured within the range of 50 to 220° C. of the heat roller.

(7) Storage Stability: 100 g of toner was put into a glass bottle and the bottle was sealed. After 48 hours at 50° C., the cohesion of the toner was observed by naked eyes. The cohesion degrees were evaluated as follows.

⊚: No cohesion and good storage stability

◯: Minute cohesion but good storage stability

x: Serious cohesion and bad storage stability

(8) Toner Image Density Evaluation: An image was printed on an OHP film or a paper with a black-and-white printer, which had a heat roller coated with teflon and a temperature controller, and had a printing speed of 35 pages/minute. The image density of the printed image was measured with a Macbeth reflective densitometer RD918, and then evaluated as follows.

⊚: The image density is equal to or more than 1.4.

◯: The image density is equal to or more than 1.2.

x: The image density is less than 1.2.

The abbreviations used in Examples and Comparative examples are as follows.

TPA: terephthalic acid

IPA: isophthalic acid

AA: adipic acid

SA: sebacic acid

TMA: trimellitic acid

TMP: trimethylolpropane

EG: ethylene glycol

PBE: polyoxypropylene-(2,3)-2,2-bis(4-hydroxyphenyl)propane

EBE: polyoxyethylene-(2,3)-2,2-bis(4-hydroxyphenyl)propane

Catalyst A: titanium dioxide and silicon dioxide coprecipitates

Catalyst B: tetrabutyl titanate

Catalyst C: antimony trioxide

Catalyst D: dibutyl tin oxide

Stabilizer: triethyl phosphate

### EXAMPLES 1 TO 3, COMPARATIVE EXAMPLES 1 to 3

Preparation of Polyester Resin

The reactant, of which the kind and amount are shown in Table 1, was put into 2 L reactor equipped with a stirring apparatus and a flow-out condenser. While slowly increasing the temperature to 250° C. and flowing out water(byproduct) from the reactor, the esterification reaction was carried out under nitrogen flow. After completion of generation and flow-out of water, the reactant was transferred to a polycondensation reactor equipped with a stirring apparatus, a cooling condenser, and a vacuum system, and 400 ppm of catalyst with respect to the total acid component, and 300 ppm of stabilizer with respect to the total acid component were added to the reactant. While increasing the temperature to 250° C. and decreasing the pressure to 50 mmHg for 30 minutes, excess of the diol was flowed out. Next, the pressure was slowly reduced to 0.1 mmHg, and under high vacuum, the reaction was carried out until a predetermined stirring torque occurred to obtain a polyester resin. The softening temperature, Tg, and acid value of the prepared polyester resin were represented on Table 1.

Preparation of Toner

50 weight part of the obtained polyester resin, 45 weight part of magnetite as a magnetic material, 2 weight part of azo-dye metal complex as an electrification control agent, 3 weight part of polypropylene wax were mixed with a mixer, melted and kneaded in an extruder, pulverized with a zet mill pulverizer, classified with a windforce classifier, and then were coated with 1 weight part of silica and 0.2 weight part of titanium dioxide to obtain toner particle having a volume average particle diameter of 8 to 9 micrometer. The minimum fixing temperature, offset temperature, storage stability, and toner image density of the produced toner particle were determined and represented in Table 1.

TABLE 1

| | | | | Comparative | Comparative | Comparative |
|---|---|---|---|---|---|---|
| | Example 1 | Example 2 | Example 3 | example 1 | example 2 | example 3 |
| TPA (mole part) | 75 | 93 | 70 | 60 | 75 | 0 |
| IPA (mole part) | 25 | 0 | 20 | 15 | 25 | 67 |
| TMA (mole part) | 3 | 0.5 | 28 | 3 | 0.2 | 33 |
| AA (mole part) | 0 | 7 | 0 | 25 | 0 | 0 |
| SA (mole part) | 0 | 0 | 10 | 0 | 0 | 0 |
| EG (mole part) | 44 | 44 | 44 | 44 | 44 | 44 |
| EBE (mole part) | 18 | 18 | 18 | 18 | 18 | 18 |
| PBE (mole part) | 18 | 18 | 18 | 18 | 18 | 18 |
| TMP (mole part) | 20 | 20 | 20 | 14 | 14 | 14 |
| Polymerization | 155 | 175 | 149 | 163 | 201 | 45 |
| time (minute) | | | | | | |
| Polymerization | Normal | Normal | Normal | Normal | Normal | Gelation |
| product | | | | | | |
| Softening | 179 | 150 | 189 | 162 | 172 | 225 |
| temperature (° C.) | | | | | | |
| Tg (° C.) | 66 | 57 | 69 | 48 | 47 | 92 |
| Acid value (KOH | 8 | 2 | 18 | 2 | 6 | — |
| mg/g) | | | | | | |
| Minimum fixing | 125 | 138 | 127 | 120 | 126 | — |
| temperature (° C.) | | | | | | |
| Offset | 220 | 216 | 220 | 215 | 187 | — |
| temperature (° C.) | | | | | | |
| Storage stability | ⊚ | ⊚ | ⊚ | X | X | ⊚ |
| Toner image | ⊚ | ⊚ | ⊚ | ◯ | X | — |
| density | | | | | | |

As shown Table 1, in case of preparation of polyester resin according to Examples, the polymerization reaction time was short, and the softening temperature, Tg, and acid value were suitable to produce a toner. Accordingly, the produced toner had good properties in the low temperature fixing property, high temperature fixing property, storage stability, and image condition. On the contrary, when the amount of the aromatic dibasic acid was less than 80 mol % with respect to the total dibasic acid (Comparative example 1), Tg was lowered, and the storage stability of the toner was deteriorated. Therefore, the toner of Comparative example 1 was less adhered to the photosensitive drum in a developing machine, which results in the unclearness of image. When the amount of the trivalent acid was less than 0.5 mol % with respect to the total dibasic acid (Comparative example 2), Tg was lowered, and the storage stability of the toner was deteriorated. Therefore, the toner of Comparative example 2 was less supplied to the photosensitive drum in a developing machine, which results in the unclearness of image and a deteriorated image precision. Also, when the amount of the trivalent acid was more than 30 mol % with respect to the total dibasic acid (Comparative example 3), it is impossible to obtain polyester from the reactor due to the gelation in the polycondensation reaction, and the acid value measurement was impossible because the polyester resin was not dissolved with dichloromethane due to the gelation, and the toner production was impossible due to the high softening temperature of the polyester resin.

### EXAMPLES 4 TO 6, COMPARATIVE EXAMPLES 4 TO 7

Except for using the reactant, of which the kind and amount are shown in Table 2, the polyester resin and the toner were prepared with the method of Example 1. The softening temperature, Tg, minimum fixing temperature, offset temperature, storage stability and toner image density of the obtained polyester resin or the toner were determined and represented in Table 2.

TABLE 2

| | | | | Comparative | Comparative | Comparative | Comparative |
|---|---|---|---|---|---|---|---|
| | Example 4 | Example 5 | Example 6 | example 4 | example 5 | example 6 | example 7 |
| TPA (mole part) | 60 | 62 | 40 | 75 | 75 | 75 | 75 |
| IPA (mole part) | 40 | 30 | 55 | 25 | 25 | 25 | 25 |
| TMA (mole part) | 2 | 3 | 3 | 3 | 3 | 3 | 3 |
| AA (mole part) | 0 | 0 | 5 | 0 | 0 | 0 | 0 |
| SA (mole part) | 0 | 8 | 0 | 0 | 0 | 0 | 0 |
| EG (mole part) | 16 | 73 | 16 | 8 | 83 | 16 | 30 |
| EBE (mole part) | 28 | 10 | 41 | 36 | 6 | 50 | 7 |
| PBE (mole part) | 42 | 8 | 41 | 42 | 6 | 42 | 7 |
| TMP (mole part) | 14 | 20 | 3 | 14 | 4 | 14 | 56 |
| Polymerization | 158 | 165 | 189 | 560 | 185 | 690 | 35 |
| time (minute) | | | | | | | |
| Polymerization | Normal | Normal | Normal | Non- | Normal | Non- | Gelation |
| product | | | | reaction | | reaction | |
| Softening | 162 | 175 | 134 | 87 | 171 | 95 | 231 |
| temperature (° C.) | | | | | | | |
| Tg (° C.) | 61 | 64 | 52 | 37 | 46 | 40 | 91 |
| Acid value (KOH | 11 | 4 | 5 | 29 | 7 | 26 | — |
| mg/g) | | | | | | | |
| Minimum fixing | 123 | 127 | 121 | — | 126 | — | — |
| temperature (° C.) | | | | | | | |
| Offset | 214 | 218 | 206 | — | 217 | — | — |
| temperature (° C.) | | | | | | | |
| Storage stability | ⊚ | ⊚ | ⊚ | X | X | X | ⊚ |
| Toner image | ⊚ | ⊚ | ⊚ | — | ◯ | — | — |
| density | | | | | | | |

As shown in Table 2, when prepared according to Examples, the polyester resin and the toner had good properties. On the contrary, when the amount of aliphatic diol was less than 10 mol % with respect to the total dibasic acid (Comparative example 4), the reaction rate was considerably slow due to the increased amount of aromatic diol having relatively slow reaction rate, and it was impossible to produce a toner due to the low softening temperature and Tg. When the amount of aliphatic diol was more than 80 mol % with respect to the total dibasic acid (Comparative example 5), the fixing property of the produced toner was fine, but the storage stability was deteriorated due to the low Tg. When aromatic diol which was bisphenol A derivatives was more than 90 mol % with respect to the total dibasic acid (Comparative example 6), the reaction rate was considerably slow due to the increased amount of aromatic diol having relatively slow reaction speed, and it was impossible to produce a toner due to the low softening temperature and Tg. Also, when the amount of the trihydric or higher alcohol was more than 50 mol % with respect to the total dibasic acid (Comparative example 7), it was impossible to obtain polyester resin from the reactor due to the gelation during the polycondensation reaction, and the acid value measurement was impossible because the polyester resin was not dissolved with dichloromethane, and the toner production was impossible due to the high softening temperature of the polyester resin.

### EXAMPLES 7 TO 10, COMPARATIVE EXAMPLES 8 TO 13

As shown in Table 3, except for using different kind and amount of polycondensation catalysts, the polyester resin and the toner were prepared with the method of Example 1. The softening temperature, Tg, minimum fixing temperature, offset temperature, storage stability and toner image density of the obtained polyester resin or the toner were determined and represented on Table 3.

TABLE 3

| | | | | | | | Comparative | Comparative | Comparative | Comparative |
|---|---|---|---|---|---|---|---|---|---|---|
| | | | | Example | Comparative | Comparative | example | example | example | example |
| | Example 7 | Example 8 | Example 9 | 10 | example 8 | example 9 | 10 | 11 | 12 | 13 |
| Catalyst kind | A | A | A | A | A | A | A | B | C | D |
| Catalyst (ppm) | 4 | 4 | 400 | 400 | 1 | 400 | 500 | 400 | 400 | 400 |
| Stabilizer | 0 | 300 | 0 | 300 | 0 | 500 | 300 | 300 | 300 | 300 |
| (ppm) | | | | | | | | | | |
| Polymerization | 191 | 210 | 140 | 155 | 400 | 320 | 145 | 178 | 259 | 225 |
| time (minute) | | | | | | | | | | |
| Softening | 171 | 167 | 170 | 175 | 140 | 158 | 174 | 170 | 175 | 176 |
| temperature | | | | | | | | | | |
| (° C.) | | | | | | | | | | |
| Tg (° C.) | 66 | 65 | 65 | 66 | 61 | 62 | 66 | 65 | 66 | 66 |
| Acid value | 8 | 10 | 8 | 8 | 14 | 13 | 8 | 9 | 8 | 8 |
| (KOH mg/g) | | | | | | | | | | |
| Color-b | 1.5 | 1.0 | 3.4 | 2.0 | 4.5 | 3.5 | 5.2 | 7.3 | 6.5 | 6.0 |
| (yellowness) | | | | | | | | | | |
| Toner image | ⊚ | ⊚ | ⊚ | ⊚ | ◯ | ◯ | ◯ | X | X | X |
| density | | | | | | | | | | |

As shown in Table 3, when prepared according to Examples, the polyester resin and the toner had the good physical properties, such as productivity, yellowness, and image density. On the contrary, when the amount of catalyst A was less 4 ppm with respect to the total acid component, or the amount of stabilizer was more than 300 ppm to the total acid component (Comparative examples 8 and 9), the polymerization degree of a polyester resin was low, and productivity was not good. When the amount of catalyst A was more than 400 ppm with respect to the total acid component (Comparative example 10), the yellowness of the polyester resin and image density of the toner were not good. Also, when the polycondensation catalysts was catalyst B, C or D (Comparative examples 11 and 13), the productivity and the yellowness of the polyester resin were not good, and the image density of the toner was not good.

As described above, the toner including the polyester resin according to the present invention has superior storage stability, fixing property, coloring property, image density and transparency, and is environmentally favorable. Also, the toner of various colors can be produced with the polyester resin of the present invention. In addition, the toner has a good dispersibility during the melting and kneading process, and desirable offset preventing property and productivity.

1. A polyester resin for toner produced by carrying out esterification reaction and polycondensation reaction of reactant comprising aromatic dibasic acid of 80 to 100 mol % with respect to the total dibasic acid, trivalent or higher acid of 0.5 to 30 mol % with respect to the total dibasic acid, aromatic diol of equal to or less than 90 mol % with respect to the total dibasic acid, and aliphatic diol of 10 to 80 mol % with respect to the total dibasic acid, in the presence of a polycondensation catalyst selected from the group consisting of TiO₂/SiO₂ coprecipitates, TiO₂/ZrO₂ coprecipitates and the mixture thereof.

2. The polyester resin for toner according to claim 1, wherein the amount of the polycondensation catalyst is 4 to 400 ppm with respect to the total acid components.

3. The polyester resin for toner according to claim 1, wherein the reactant further includes a compound selected from the group consisting of aliphatic dibasic acid, trihydric or higher alcohol, a stabilizer and the mixtures thereof, and the amount of the aliphatic dibasic acid is equal to or less than 20 mol % with respect to the total dibasic acid, the amount of the trihydric or higher alcohol is 0.5 to 50 mol % with respect to the total dibasic acid, and the amount of the stabilizer is equal to or less than 300 ppm with respect to the total acid components.

4. The polyester resin for toner according to claim 1, wherein the acid value of the polyester resin is 1 to 25 KOHmg/g, the softening temperature is 130 to 190° C., and the glass transition temperature is 50 to 70° C.

5. A toner including the polyester resin of claim 1 as a binder resin.
